(19) United States
(12) Patent Application Publication
(10) Pub. No.: US 2007/0195312 A1
(43) Pub. Date: Aug. 23, 2007

(54) Refractometer

(76) Inventors: Sukru Yilmaz, Berlin (DE); Mathis Kuchejda, Berlin (DE)

Correspondence Address: DUANE MORRIS, LLP;IP DEPARTMENT, 30 SOUTH 17TH STREET, PHILADELPHIA, PA, 19103-4196, US

(21) Appl. No.: 10/556,280

(22) PCT Filed: May 14, 2004
(86) PCT No.: PCT/DE04/01050

§ 371 Date: Nov. 14, 2005

(30) Foreign Application Priority Data
May 14, 2003 (DE) 203 07 675.3

(51) Int. Cl. G01N 21/41

(52) U.S. Cl. 356/136

(57) ABSTRACT

The present invention pertains to a refractometer with a refractometer prism, on the measuring surface of which a sample to be analyzed can be placed, which can be illuminated by a light source in such an angle range that the critical angle of the total reflection is also contained in it, and with a receiver, on which the reflected radiation falls. The light source comprises a plurality of discrete light sources, which can be activated individually or together, and their radiation can be sent in one point to the refractometer in a bundled form.

### BACKGROUND OF THE INVENTION

The present invention pertains to a refractometer with a refractometer prism, on the measuring surface of which a sample to be analyzed can be placed, which [sample] can be exposed to the light of a light source in such an angle range that the critical angle of total reflection is also contained in it, and a receiver, on which the reflected radiation falls.

Refractometers are normally used with the yellow Na line with the wavelength of 589 nm for measuring the refractive indices of liquids, solids or gaseous substances. However, the refractive index is known to be a function of the wavelength of the light used and increases toward shorter wavelengths. The course of this function provides important information on the properties of the material and is usually expressed by the so-called Abbe number, which can be calculated as an arithmetic constant from the refractive indices at three wavelengths.

The object of the present invention is to simplify the measuring possibilities of the refractometer and to improve the informative value of the measurement.

This object is accomplished according to the present invention with the features of patent claim 1.

Preferred embodiments appear from the features of the subclaims.

The solution according to the present invention makes it possible in a digital refractometer with discrete light sources (LEDs or white light lamps) with downstream interference filters to generate the wavelengths such that the refractive index of the sample to be analyzed can be measured at the particular active wavelength in case of automatic activation of the desired light source. The next light source is then activated and the measurement is repeated.

The converging of the beams of the discrete light sources can be brought about by a glass fiber bundle or by means of an optical diffraction grid. The technical embodiment makes provisions for the light sources having different colors, comprising white or colored LEDs or white light lamps and, if needed, downstream interference filters, illuminating a light guide bundle with as many arms as the input and for these to be merged in this into a single, round light source.

Discrete light sources of number n are provided for this purpose, which are followed downstream by a glass fiber bundle with n inputs and one output, wherein the light sources are arranged on the input side in front of the different inputs of the glass fiber bundle such that all wavelengths are represented at the output-side end of the glass fiber bundle.

To improve the coupling of the light into the discrete beam paths, lenses may be provided, which at the same time optimize the transmission of the light through the interference filters and make possible a more defined effective wavelength and full width at half-maximum.

The light source may comprise discrete light sources, whose radiations are reflected by means of an optical diffraction grid to one point, where they are then coupled into a glass fiber.

The discrete light sources are arranged here such that at the selected angle of incidence they lead to a diffraction angle that is equal for all wavelengths.

According to another embodiment, a direct vision prism with dispersing property (dispersion prism) may be provided instead of the optical diffraction grid.

It is also possible to provide a transmission diffraction grid with dispersing property instead of the optical reflection diffraction grid.

Finally, the glass fiber bundle may be designed such that it has a rectangular shape on the input side and a round shape on the output side; that the spectra of the individual light sources are directed in parallel to the short side and are always longer than the width of the cross section converter, and that a section, which determines the spectral full width at half-maximum of the entering light, can be selected from the spectral distribution of the light exiting the glass fiber bundle.

A one-dimensional CCD photodiode cell is provided according to the present invention as the receiver.

The present invention will be explained below on the basis of the drawings.

In the drawings,

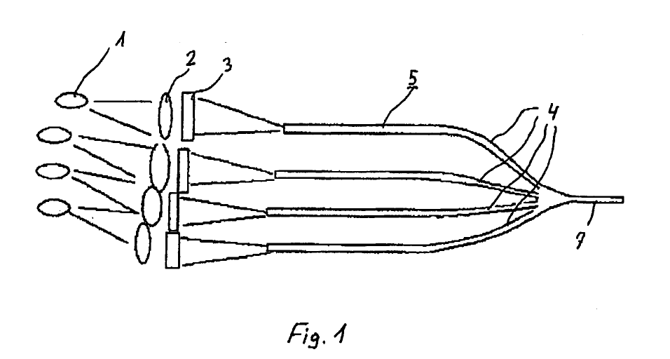

FIG. 1 shows a schematic view of the glass fiber bundle, and

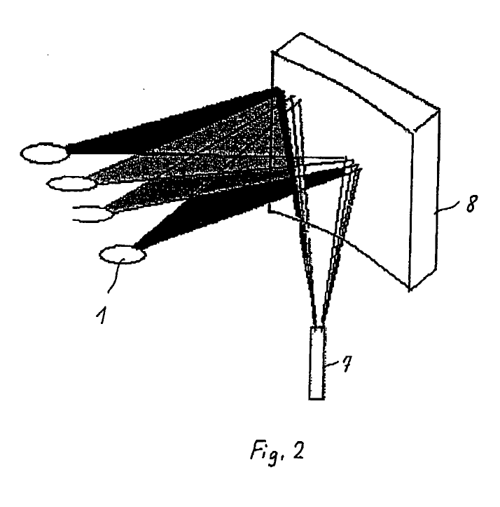

FIG. 2 shows the arrangement with a diffraction grid.

Separate radiations are generated from discrete light sources 1, namely, either white light lamps or colored LEDs, and these radiations are sent to a plurality of arms 4 of a glass fiber bundle 5 through lenses 2 and interference filters 3 in the exemplary embodiment being shown. A punctiform light beam 7 is generated at the output 6 by bundling, and this light beam is then sent to the measuring surface of the refractometer.

The radiation of the discrete LEDs 1 is sent in the embodiment according to FIG. 2 to an optical diffraction grid 8 and is reflected there such that concentration to a point takes place.

The property of an optical grid of reflecting the light at different angles depending on color is advantageously used here to recombine different colored light sources at different angles of incidence. The present invention provides, in a certain way, for the reversed function of such a grid, so that the light paths are passed through in another direction.

The individual light sources are arranged now such that red, yellow, green and blue-colored LEDs illuminate the concave grid at correct angles and they coincide into a single light point after reflection. If the LEDs are operated now one after another, the refractometer would be supplied with freely selected wavelengths as the illumination and perform corresponding measurements. This technical solution has, moreover, the advantage that it may not be necessary to use expensive interference filters, because the size of the opening toward the refractometer is one of the factors determining the purity of the color. The full width at half-maximum of the light can thus be set by selecting the entry opening.

The number of LED light sources itself is limited by the geometrically attainable minimum distances between the individual LEDs or lamps. A relatively broad spectral range can be covered by selecting especially suitable light sources. The wavelengths can be selected freely within certain limits.

1. Refractometer with a refractometer prism, on the measuring surface of which a sample to be analyzed can be placed, which can be illuminated by a light source in such an angle range that the critical angle of the total reflection is also contained in it, and with a receiver, on which the reflected radiation falls, characterized in that the light source comprises a plurality of said discrete light sources (1), which can be activated individually or together, and their radiation can be sent in one point onto the refractometer in a bundled manner.

2. Refractometer in accordance with claim 1, characterized in that the light source comprises a plurality of white light lamps arranged at preset spaced locations next to one another.

3. Refractometer in accordance with claim 1, characterized in that the light source comprises a plurality of colored LEDs arranged at preset spaced locations next to one another.

4. Refractometer in accordance with claim 3, characterized in that a said interference filter (3), by means of which the light of the LEDs can be filtered to a desired wavelength, is arranged downstream of each LED.

5. Refractometer in accordance with one of the above claims, characterized in that the receiver is a one-dimensional CCD photodiode cell.

6. Refractometer in accordance with one of the above claims, characterized in that discrete light sources of the number n are provided, which are followed downstream by a said glass fiber bundle (5) with n inputs and one said output (6), wherein the said light sources are arranged on the input side in front of the different inputs of the said glass fiber bundle such that all wavelengths are represented at the output-side end of the said glass fiber bundle.

7. Refractometer in accordance with claim 6, characterized in that said lenses (2), which optimize the transmission of the light through the said interference filters (3) at the same time and make possible a more defined effective wavelength and full width at half-maximum, are provided to improve the coupling of the light into the discrete beam paths.

8. Refractometer in accordance with claim 1, characterized in that the light source comprises discrete light sources, whose radiations are reflected by means of a said optical diffraction grid (8) onto a point, where they are then coupled into a glass fiber.

9. Refractometer in accordance with claim 8, characterized in that the said discrete light sources are arranged such that at the selected angle of incidence they lead to a diffraction angle that is the same for all wavelengths.

10. Refractometer in accordance with claim 8, characterized in that a said direct vision prism with dispersing property (dispersion prism) is provided instead of the said optical diffraction grid.

11. Refractometer in accordance with claim 8, characterized in that a monochromatic lens is provided instead of the said optical diffraction grid.

12. Refractometer in accordance with claim 8, characterized in that a said transmission diffraction grid with dispersing property is provided instead of the said optical reflection diffraction grid.

13. Refractometer in accordance with one of the claims 1 through 7 characterized in that the said glass fiber bundle is designed such that it has a rectangular shape on the input side and a round shape on the output side, that the spectra of the said individual light sources are directed in parallel to the short side and are always longer than the width of the cross section converter, and that a section, which determines the spectral full width at half-maximum of the entering light, can be selected from the spectral distribution of the light exiting the glass fiber bundle.
